(19) United States
(12) Patent Application Publication
(10) Pub. No.: US 2025/0053849 A1
(43) Pub. Date: Feb. 13, 2025

(54) SHADOW HAMILTONIAN SIMULATION USING A QUANTUM COMPUTER

(71) Applicant: Google LLC, Mountain View, CA (US)

(72) Inventors: Thomas Eugene O'Brien, Munich (DE); Rolando Diego Somma, Santa Fe, NM (US); Ryan Babbush, Venice, CA (US)

(21) Appl. No.: 18/785,890

(22) Filed: Jul. 26, 2024

Related U.S. Application Data
(60) Provisional application No. 63/517,314, filed on Aug. 2, 2023.

(51) Int. Cl. G06N 10/80; G06N 10/40; G06N 10/60

(52) U.S. Cl. CPC G06N 10/80; G06N 10/40; G06N 10/60

(57) ABSTRACT

Methods, systems, and apparatus for quantum simulation of a quantum system. In one aspect, a method includes, for an observable generated from a set of observables, wherein a commutator of each observable in the set of observables with the first Hamiltonian is equal to a combination of observables in the set of observables: encoding, by a quantum computer, a vector of coefficients of a time-dependent representation of the observable in a quantum state of a register of qubits; simulating, by the quantum computer, time evolution of the quantum state under a second Hamiltonian to obtain an evolved quantum state, wherein the second Hamiltonian comprises a matrix of complex weights in the linear combination of observables; measuring, by the quantum computer, the evolved quantum state; and post-processing, by a classical processor, obtained measurement results to obtain an expectation value of the observable.

### CROSS-REFERENCE TO RELATED APPLICATIONS

This application claims the benefit under 35 U.S.C. § 119(e) of U.S. Patent Application No. 63/517,314, entitled “SIMULATION OF QUANTUM SYSTEMS WITH LIE ALGEBRAIC STRUCTURE USING A QUANTUM COMPUTER,” filed Aug. 2, 2023. The disclosure of the foregoing application is incorporated herein by reference in its entirety for all purposes.

### BACKGROUND

This disclosure relates to quantum computing and quantum simulation.

### SUMMARY

This disclosure describes exponentially-improved simulations of quantum systems using a quantum computer.

In general, one innovative aspect of the subject matter described in this specification can be implemented in a method for quantum simulation of a quantum system characterized by a first Hamiltonian, the method comprising: for an observable generated from a set of observables, wherein a commutator of each observable in the set of observables with the first Hamiltonian is equal to a linear combination of observables in the set of observables: encoding, by a quantum computer, a vector of coefficients of a time-dependent representation of the observable in a quantum state of a register of qubits included in the quantum computer; simulating, by the quantum computer, time evolution of the quantum state under a second Hamiltonian to obtain an evolved quantum state, wherein the second Hamiltonian comprises a matrix of complex weights in the linear combination of observables; measuring, by the quantum computer, the evolved quantum state to obtain measurement results; and post-processing, by a classical processor, the measurement results to obtain an expectation value of the observable.

Other implementations of these aspects include corresponding computer systems, apparatus, and computer programs recorded on one or more computer storage devices, each configured to perform the actions of the methods. A system of one or more classical and quantum computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In some implementations the observables in the set of observables generate a Lie algebra; the first Hamiltonian comprises a second linear combination of observables in the set of observables; and the second Hamiltonian comprises a complex valued matrix of real weights in the second linear combination of observables and structure factors of the Lie algebra.

In some implementations the first Hamiltonian is an element of a Lie algebra; the set of observables define a real vector space; and the real vector space is invariant to conjugation of operators that are dependent on the Lie algebra.

In some implementations the first Hamiltonian has a larger dimension than the second Hamiltonian.

In some implementations the vector of coefficients has a dimension M equal to a number of observables included in the set of observables; and the register of qubits comprises at least ┌log(M)┐ qubits.

In some implementations encoding the vector of coefficients of the time-dependent representation of the observable in the quantum state of the register of qubits included in the quantum computer comprises preparing the register of qubits in an initial quantum state that is proportional to the vector of coefficients at an initial time.

In some implementations preparing the register of qubits in the initial quantum state costs poly(n), where n represents the number of qubits in the register.

In some implementations amplitudes of the initial quantum state are proportional to an expectation value of the observable with respect to an initial state of the quantum system.

In some implementations simulating time evolution of the quantum state under the second Hamiltonian to obtain the evolved quantum state comprises performing a simulation in space equal to the dimension of the vector of coefficients.

In some implementations amplitudes of the evolved quantum state are proportional to a time-dependent expectation value of the observable with respect to an initial state of the quantum system.

In some implementations simulating time evolution of the quantum state under the second Hamiltonian for a time t comprises complexity poly(n,t), where n represents the number of qubits in the system.

In some implementations the quantum system comprises a spin system.

In some implementations the first Hamiltonian comprises an Ising model in a transverse field; observables included in the first Hamiltonian generate a Lie algebra of a special unitary group of degree N, wherein N represents a number of spin orbitals in the quantum system; and either the encoded vector of coefficients of the time-dependent representation of the observable is proportional to expectation values of the observables included in the first Hamiltonian, the observables comprising {XⱼXₖ, YⱼYₖ, Zⱼ} where Xⱼ represents a Pauli X operator applied to spin j, Yⱼ represents a Pauli Y operator applied to spin j, and Zⱼ represents a Pauli Z operator applied to spin j; or the encoded vector of coefficients of the time-dependent representation of the observable is proportional to expectation values of the observables included in the first Hamiltonian, the observables comprising {XⱼXₖX_{j′}X_{k′},XⱼXₖY_{j′}Y_{k′},XⱼXₖZ_{j′},YⱼYₖY_{j′}Y_{k′},YⱼYₖZ_{j′},ZⱼZₖ}.

In some implementations the quantum system comprises a free fermion system on a lattice.

In some implementations the first Hamiltonian comprises a linear combination of products of fermionic creation and annihilation operators; and the set of observables generate a Lie algebra of a unitary group of degree N, wherein N represents a number of lattice sites in the lattice.

In some implementations the quantum simulation simulates dynamics of the first Hamiltonian within a one-excitation manifold and wherein each observable in the set of observables is equal to a sum of an annihilation operator for a respective spin and a creation operator for the respective spin.

In some implementations the quantum simulation simulates Landau-Lifshits dynamics and the observables in the set of observables generate a Lie algebra of a unitary group of degree N, wherein N represents system size; the quantum simulation simulates the dynamics of a fermionic system and the observables in the set of observables generate a Lie algebra of a special unitary group of degree 2N; or the quantum simulation simulates the dynamics of a bosonic system and the observables in the set of observables generate a Lie algebra of a sympletic group of degree 2N.

In some implementations the observable generated from the set of observables comprises an element of the set of observables or a product of elements of the set of observables.

In general, another innovative aspect of the subject matter described in this specification can be implemented in a method for spectroscopy of a quantum system characterized by a first Hamiltonian, the method comprising: for a set of observables, wherein a commutator of each observable in the set of observables with the first Hamiltonian is equal to a linear combination of observables in the set of observables: mapping, by a classical processor, the first Hamiltonian to a second Hamiltonian with lower dimension than the first Hamiltonian, comprising generating a matrix wherein elements of the matrix correspond to respective complex weights in the linear combinations of observables; performing, by a quantum computer, spectroscopy on the second Hamiltonian to obtain spectroscopy data; and processing, by the classical processor, the spectroscopy data to determine spectral and response properties of the quantum system.

Other implementations of these aspects include corresponding computer systems, apparatus, and computer programs recorded on one or more computer storage devices, each configured to perform the actions of the methods. A system of one or more classical and quantum computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In some implementations the observables in the set of observables generate a Lie algebra; the first Hamiltonian comprises a second linear combination of observables in the set of observables; and the second Hamiltonian comprises a complex valued matrix of real weights in the second linear combination of observables and structure factors of the Lie algebra.

In some implementations the first Hamiltonian is an element of a Lie algebra; the set of observables define a real vector space; and the real vector space is invariant to conjugation of operators that are dependent on the Lie algebra.

In some implementations performing spectroscopy on the second Hamiltonian comprises implementing a quantum Kernel Polynomial method.

In some implementations the method further comprises using block encodings of the second Hamiltonian.

In some implementations the quantum system comprises a free fermion system on a lattice.

In some implementations the first Hamiltonian comprises a linear combination of products of fermionic creation and annihilation operators; and the set of observables generate a Lie algebra of a unitary group of degree N, wherein N represents a number of lattice sites in the lattice.

In some implementations the quantum system comprises a spin system.

The subject matter described in this specification can be implemented in particular embodiments so as to realize one or more of the following advantages.

A system implementing the presently described techniques can perform quantum simulations of quantum systems, e.g., to compute expectation values or spectral properties of the quantum systems, with an exponential improvement over conventional classical techniques. In addition, a system implementing the presently described techniques can perform quantum simulations of quantum systems with an improvement over conventional quantum techniques. By working in the Heisenberg picture where quantum states are static and operators evolve in time, an equivalent Schrödinger equation is computed on a vector of expectation values. By construction, the spectrum and time dynamics of the vector yields information about the original quantum system. However, the dimension of the Hilbert space of this vector is (exponentially) lower than the dimension of the Hilbert space of the original quantum system. Therefore, performing the quantum simulation using the vector of expectation values is computationally more efficient (e.g., requires less physical qubits and/or less control and measurement operations) than performing the quantum simulation of the original quantum system yet still provides information about the original quantum system.

The approach is thus directed to the underlying quantum hardware on which it is implemented, adapted to take advantage of the nature of this architecture and to avoid unnecessary computing overhead. In particular, by encoding a vector of coefficients of a time-dependent representation of the observable in a physical quantum state of a register of qubits, the proposed technique is able to make use of the properties of said qubit during quantum computing operations in order to derive information about the simulated quantum system. The relationship between the first Hamiltonian (in the domain of the quantum system to be simulated) and the second Hamiltonian (under which evolution of the quantum computer operates, also referred to herein as a shadow Hamiltonian) takes advantage of the behavior and properties of the quantum computer/qubits in order to offer substantial benefits.

In addition, the approach provides a means to measure physical properties of the quantum system to be simulated, e.g., energy levels, through indirect, physical measurements of qubits of the quantum computer.

In the following, N refers to the number of sites or corresponding degrees of freedom of the original system. The dimension of the Hilbert space that is used to represent the original system is D=exp(N), usually D=2^{N}, and the Hilbert space is the complex vector space C²^{_{N}}. Another relevant parameter is M, which represents the dimension of a set of relevant observables, and n, which is the number of qubits our quantum algorithm uses. For these problems, n=log(M). In particular, if M is polynomial in the number of sites, the dimension D is doubly exponential in n.

In addition, the presently described techniques are adapted to a specific technical class of Hamiltonians: those for which the equivalent Schrödinger equation is sparse. This allows a doubly-exponential speedup over exact classical simulation of the D-dimensional electronic many-body wavefunction, as quantities can be estimated in time O(polylog N) where N represents system size. Conventional quantum computing techniques that use Lie algebra theory to study quantum systems consider systems where the Hamiltonian is dense and do not achieve an exponential speedup compared to classical methods. This makes the presently described techniques a compelling use-case of a fault-tolerant quantum computer to solve problems that may be classically intractable.

In addition, the presently described techniques can be advantageously applied to a wide range of systems and applications. For example, the Lie algebra structure required for the presently described techniques can be found in non-interacting free fermion systems. These systems have the required sparse structure for an exponential speedup over classical methods when one makes the further common approximation of the tight-binding model. This replaces the typically-dense t_{i,j} matrix with a sparse matrix that corresponds to a weighted adjacency matrix of some lattice. This structure is widely used in classical computational chemistry and physics simulations with an O(poly(N)) cost. In contrast, the proposed quantum simulation approach can be implemented with logarithmic cost in N, an exponential improvement over classical methods for this problem. This is a clear advantage to exact simulation of the D-dimensional electronic many-body wavefunction. Though the free-fermion approximation is not exact, it is perhaps the most successful approximate theory in condensed matter physics.

The Kernel polynomial method has already been used successfully on classical computers for tight-binding models with over 10⁶ lattice sites. Using a system register of e.g. 60 qubits could allow a quantum computer to simulate approximately 1018 lattice sites, allowing for simulations to be increased towards macroscopic size. Going slightly larger, the electronic structure of 1 mol of copper atoms using 83 qubits for the system register (assuming 9 orbitals per Copper atom are needed) could be simulated. This could allow estimation of the electronic structure associated with 3D defects such as shears or bubbles. Block encodings of the second Hamiltonian described below for lattice systems can be encoded using LCU techniques: the SELECT operation can be encoded via controlled adder circuits, while PREPARE operations can be implemented by direct construction or QROM. This also allows for pseudorandom disorder to be added by a quantum encoding of a simple hash table.

Further, the Lie algebra structure described herein (e.g., the structure that is derivable from the single particle Hamiltonian of Eq. (8)) does not require that the creation/annihilation operators be fermionic. More generally, the presently described techniques can be used to study quadratic Hamiltonians of bosonic operators, or more generally of non-Abelian anyons. This could enable, e.g. the study of large lattices of light or exotic quasiparticles.

Further, the Lie algebra structure described herein can additionally be used to study SU(N) theories at large N. This can be used to simulate generalized spin dynamics, which is an approximation beyond the celebrated Landau-Lifshitz approximation of a quantum spin system and would allow studies of magnetism and large scales.

The details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example system for simulating the time evolution of quantum systems with a Lie algebraic structure using a quantum computer.

FIG. 2 is a flow diagram of an example process for quantum simulation of the time dynamics of a quantum system.

FIG. 3 is a block diagram of an example system for computing spectral properties of quantum systems with a Lie algebraic structure using a quantum computer.

FIG. 4 is a flow diagram of an example process for computing spectral properties of a quantum system,

FIG. 5 depicts an example classical-quantum computing system.

### DESCRIPTION

This specification describes systems and processes for simulating quantum systems using shadow Hamiltonian simulation. Shadow Hamiltonian simulation uses a representation of quantum states where amplitudes are proportional to the time-dependent expectations of relevant observables or operators. In this representation, and if a particular invariance property is satisfied, the state evolves according to its own Schrödinger equation specified by a Hamiltonian H_{S}. This Hamiltonian is obtained from the commutation relations of the original Hamiltonian H, which acts on the space of the system, and the corresponding encoded operators, S.

The systems and processes can be used to efficiently simulate various quantum systems including free fermions and free bosons on a lattice of N=exp(n) sites (i.e., with an exponentially large number of fermionic or bosonic modes), and generalized spin dynamics. The techniques described herein can be used to study spectral and response properties, and to perform time dynamics. As will be described below, in order to do so, they make use of the particular properties of the quantum computing system/quantum computing device on which aspects of the method operate. Under certain, well-specified conditions, all processes have an asymptotic complexity that is polynomial in n, which represents an exponential improvement over corresponding classical processes in the general case.

The quantum systems to be simulated using the techniques described in the present disclosure include quantum systems that are characterized by a Hamiltonian H and satisfy a preservation condition given by the following property: there exists a set S of M Hermitian operators or observables Oⱼ, j∈[M]{1, . . . M}, such that

$$[ H , {O}_{j} ] = {\sum }_{k = 1}^{M} {h}_{j , k} {O}_{k} . \qquad ( 1 )$$

where [H, Oⱼ] represents the commutator of the Hamiltonian H and the observable Oⱼ, and h_{j,k} are imaginary (in some implementations time-dependent) coefficients. In some implementations the preservation condition can be referred to as an invariance property, where H and S satisfy the invariance property if [H, Oⱼ]=−Σₖ₌₁^{M} h_{j,k}Oₖ is satisfied for all j∈[M] and all times.

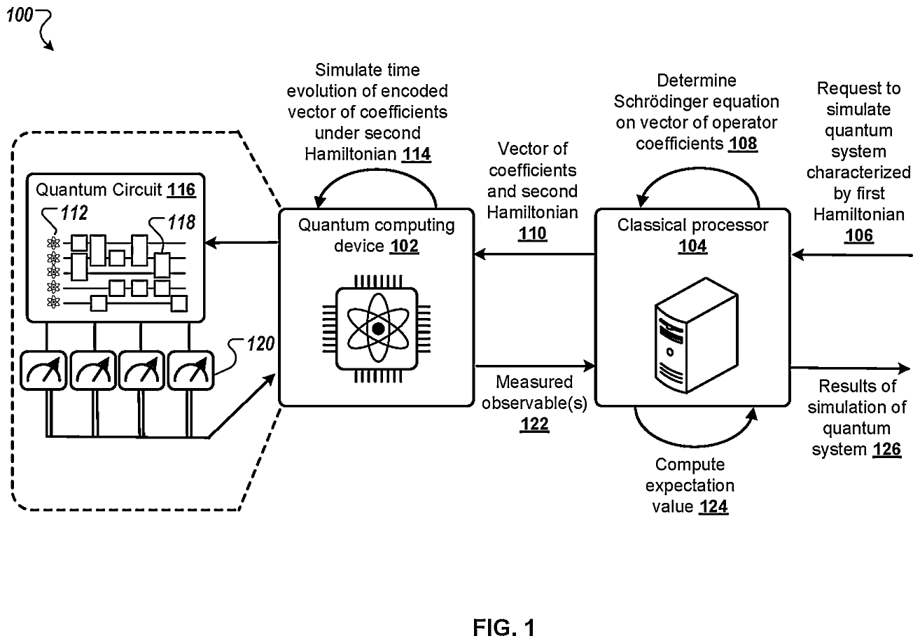

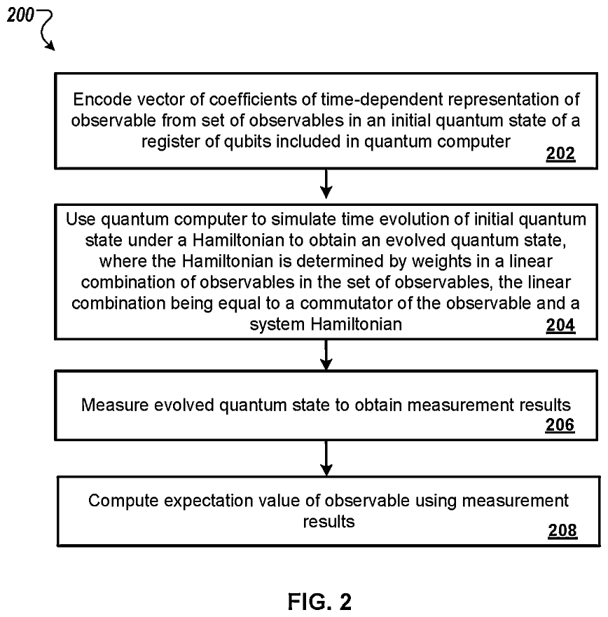

Since the commutator is anti-Hermitian, h_{j,k} is imaginary and gives an M×M Hermitian matrix called X. X is referred to herein as a shadow Hamiltonian (and is also referred to as a second Hamiltonian, e.g., with reference to FIGS. 1 and 2). Equation (1) above can also be written as [H, \vec{O}]=−X\vec{O} where \vec{O}: (O₁, . . . , O_{M})^{T} is a vector of operators.

In some implementations the observables are orthogonal, i.e., the observables satisfy tr[OⱼOₖ]=δ_{j,k}, where “tr” represents the trace and δ_{j,k} represents a Kronecker delta. Cases of particular interest are those where the dimension M is much smaller than the dimension of the Hilbert space that the Hamiltonian H acts on. For example, M may be quadratic on the number N of spins or spin orbitals in the system, in which case the Hilbert space is C²^{^{N}} (this example arises when the underlying algebra is the special unitary group of degree N).

In some implementations the observables Oⱼ can be local operators supported on small sets of qubits. The Heisenberg picture is useful to understand how expectations evolve in time. In the Heisenberg picture, states are static and operators evolve in time t. That is, if a time-dependent version of the variable Oⱼ is given by Oⱼ(t):=e^{itH}Oⱼe^{-itH} for all j∈[M], then the time-dependent versions of the variables evolve as

$$\frac{d}{d t} {O}_{j} = i [ H , {O}_{j} ] = i {\sum }_{k = 1}^{M} {h}_{j , k} {O}_{k} \qquad ( 2 )$$

where Oⱼ(0)≡Oⱼ.

Therefore, any time-dependent observable Oⱼ(t) can be written as the linear combination of the observables O₁, . . . , O_{M}, and the same applies to the expectations with respect to the state ρ. In particular, any time-dependent observable can be expressed as Σₘ pₘ(t) [symbol] Oₘ [symbol] , where pₘ(t)∈R for all m∈[M]. Eq. (2) then gives a Schrödinger equation acting on the vector \vec{p}(t):=(p₁(t), . . . , p_{M}(t))^{T}:

$$\frac{\partial }{\partial t} \vec{p} ( t ) = - iX \vec{p} ( t ) \qquad ( 3 )$$

Using the presently described techniques, the vector \vec{p}(t) and the matrix X are encoded as states and operators on a quantum computer, and properties of the (exponentially) larger system are calculated using this representation. Because the norm of the vector \vec{p}(t) is preserved in Eq. (3), Eq. (1) above can be referred to as a preservation condition.

In standard Hamiltonian simulation a state | [symbol] (t) [symbol] is evolved according to the Schrödinger equation. In the present disclosure, the state that encodes the vector \vec{p}(t) provides a compressed representation of | [symbol] (t) [symbol] that does not necessarily allow for a reconstruction of | [symbol] (t) [symbol] but does allow for certain quantities that depend on expectation values of the observables O₁, . . . , O_{M} to be recovered. These expectation values are stored in the amplitudes of the state that encodes the vector \vec{p}(t). The state that encodes the vector \vec{p}(t) can therefore be referred to as a shadow state of | [symbol] (t) [symbol] with respect to the set of observables. That is,

$$\vert ρ ; S 〉 = \frac{1}{\sqrt{A}} ( \begin{matrix}〈 {O}_{1} 〉 \\ … \\ 〈 {O}_{M} 〉\end{matrix} ) = \frac{1}{\sqrt{A}} {\sum }_{m ∈ [ M ]} 〈 {O}_{m} 〉 \vert m 〉$$

where [symbol] Oₘ [symbol] is the expectation value of the operator Oₘ with respect to ρ, A=Σ_{m∈[M]} [symbol] Oₘ [symbol] ² is a proportionality constant, and |m [symbol] is a computational basis state. The shadow state as defined above is defined for any time t, where the expectations [symbol] Oₘ [symbol] are obtained at the time t.

The shadow state has finite dimension M, however the state ρ can be a state of an infinite-dimensional system, e.g., a bosonic system. For example, when the set of observables is the set of all 4ⁿ products of Pauli operators acting on n qubits, and if ρ is an n-qubit pure quantum state, then the shadow state will be a 2n-qubit state since M=4ⁿ.

Because the dimension of the vector \vec{p}(t) is equal to M, this encoding requires a system register of n=log ┌(M)┐ qubits, plus possible ancilla qubits required as part of the computation. By contrast, a classical representation of the vectors \vec{p}(t) requires linear in M classical memory alone to store the vector, and the classical simulation of the evolution of \vec{p}(t) has worse scaling. For this to translate into a quantum exponential advantage in computational cost for solving a problem, the quantum algorithm should have no hidden O(N) costs. In particular, this requires that the n-qubit quantum state proportional to \vec{p}(0) can be prepared efficiently, and that the Hamiltonian X can also be simulated efficiently on a quantum computer. There exist problem instances for which the proposed quantum algorithm runs in time polynomial in n, while classical algorithms must take time polynomial in N or worse. This is because the presently described quantum algorithm can simulate any quantum computation efficiently.

One way that Eq. (1) emerges is if the observables Oⱼ generate a Lie algebra h,

$$[ {O}_{j} , {O}_{k} ] = i {\sum }_{l} {f}_{j , k , l} {O}_{k} \qquad ( 4 )$$

and H is a linear combination such as

$$H = {\sum }_{j} {g}_{j} {O}_{j} \qquad ( 5 )$$

where [Oⱼ, Oₖ] represents the commutator of Oⱼ and Oₖ, gⱼ ∈R are real valued weights, and ƒ_{j,k,l} ∈R are real valued structure factors of the algebra. These structure factors of the algebra give a fully anti-symmetric tensor, i.e., a Levi-Civita symbol that satisfies ƒ_{j,k,l}=−ƒ_{k,j,l}=−ƒ_{l,k,j}. In this case, it can be confirmed that Eq. (1) is satisfied with

$${h}_{j , k} = i {\sum }_{i} {g}_{i} {f}_{i , j , k} \qquad ( 6 )$$

This process yields a Hermitian Hamiltonian X, as required, regardless of the values of the gᵢ since h_{k,j}=i Σᵢ gᵢƒ_{i,k,j}=−h_{j,k} and h_{j,k} is imaginary. In some implementations this Hamiltonian will preserve locality properties of the original Hamiltonian H since many terms in the original Hamiltonian H commute with any observable Oⱼ.

Cases where the original Hamiltonian H∈h can also be allowed for, but the time-evolved observables Oⱼ(t) are not necessarily in the Lie algebra. That is, the set of observables {O₁, . . . , O_{M}} define a real vector space V and conjugation by operators of the form e^{ih} leave V invariant. To make the distinction, let {A₁, . . . , A_{L}} be a basis of h. It is noted that some Aⱼ can correspond to some Oₖ. Similarly, Aⱼ(t) is defined as Aⱼ(t):=e^{itH} Aⱼ(0)e^{-itH} with Aⱼ(0)≡Aⱼ for all j∈[L]. With this generalization, the vector \vec{p}(t) and matrix X are such that the dimension of \vec{p}(t) is equal to the dimension L.

The above situation occurs in some interesting examples including the following. In some implementations the quantum system to be simulated (or whose spectral properties are to be determined) can be a spin system, e.g., an Ising model in a transverse field. In these implementations the quantum system can be characterized by a Hamiltonian H=Σⱼ XⱼXⱼ₊₁+YⱼYⱼ₊₁+BZⱼ, where Xⱼ, Yⱼ, Zⱼ are Pauli operators applied to spin j and B is the external transverse field. The observables in the Hamiltonian H generate the Lie algebra so(2N) of the special unitary group SO(2N), where N represents system size. Hence, the Lie group SO(2N) not only leaves so(2N) invariant but also the products so(2N). so(2N) and so on. An encoding where \vec{p}(0) is proportional to the expectation values of {XⱼXₖ, YⱼYₖ, Zⱼ} at time t=0 can be allowed for. Another encoding is such that \vec{p}(0) is proportional to the expectations of {XⱼXₖX_{j′}X_{k′},XⱼXₖY_{j′}Y_{k′},XⱼXₖZ_{j′},YⱼYₖY_{j′}Y_{k′},YⱼYₖZ_{j′},ZⱼZₖ} at time t=0. Note that because of the way that the time-dependent observables Oⱼ(t)Oₖ(t) transform, the corresponding dynamics in the Heisenberg picture is generated by X⊗I+I⊗X or a related Hamiltonian that can be efficiently computed. This can be generalized to include the expectations of products Oⱼ(t)Oₖ(t)Oₗ(t) and so on.

In other implementations the quantum system to be simulated (or whose spectral properties are to be determined) can be a free fermion system on a lattice with N lattice sites (with or without superconductivity). In the non-superconducting case, the Lie algebra is the Lie algebra u(N) of the unitary group of degree N, where N represents system size (number of lattice sites), and is generated by the N² operators

$$\frac{1}{2} ( {c}_{i}^{†} {c}_{j} + {c}_{j}^{†} {c}_{i} ) , \frac{1}{2} ( {c}_{i}^{†} {c}_{j} - {c}_{j}^{†} {c}_{i} ) . \qquad ( 7 )$$

where cᵢ(cᵢ^{†}) represents the operator that annihilates (creates) a fermion on site i=1, . . . , N. In this case, the quantum system Hamiltonian is given by a linear combination of products of fermionic creation and annihilation operators, e.g.,

$$H = {\sum }_{i , j} {h}_{i , j} {c}_{i}^{†} {c}_{j} \qquad ( 8 )$$

where h_{i,j} are weights. In this situation, the Lie algebra preserves the number of creation and annihilation operators in a product, and so all sets of k annihilation and k′ creation operators are conserved. The set of observables can therefore include observables given by a sum of an annihilation operator for a respective spin and a creation operator for the respective spin, e.g., the set Oⱼ=(cⱼ+cⱼ^{†}) (i.e. k=0, k′=1) can be taken. In this case the shadow Hamiltonian (matrix) X=h^{T} where h is a vector of the weights in Eq. (8). This is equivalent to studying the dynamics of the original Hamiltonian H within the one-excitation manifold and is used in the condensed matter theory community.
For future reference, in this case the creation eigenoperators can be defined as

$${a}_{{}^{\vec{v}}}^{†} = {\sum }_{i} {v}_{i} {c}_{i}^{†} \qquad ( 9 )$$

where vᵢ are weights.

Reducing from the Lie algebra to creation operators has the advantage of reducing the dimension of the Hilbert space of the vector \vec{p}(t) from M=N² to N. However, this can increase the error requirements to e.g. estimate time dynamics of the expectation value [symbol] cᵢ^{†}(t)cⱼ(t) [symbol] : in some implementations for this and other quantities a larger representation may be preferable. (For example, the dynamics of 4-particle operators {cᵢ^{†} cⱼ^{†} cₖ cₗ} could be directly simulated, which would require a Hilbert space of size O(N⁴).)

In the case of free-fermion systems, one example shadow state that can be prepared efficiently is a shadow state that corresponds to a bare vacuum state. The bare vacuum state is a state that contains no particles, so is destroyed by all annihilation operators. In this state, the expectations of the quadratic Majorana operators are

$$〈 {c}_{j} {c}_{k} 〉 = \{ \begin{matrix}i if ( j , k ) = ( 2 l - 1 , 2 l ) for l ∈ n \\ 0 otherwise\end{matrix}$$

The corresponding shadow state is then (up to a global phase) given by

$$\vert ρ ; S 〉 = \frac{1}{\sqrt{n}} {\sum }_{l} \vert 2 l - 1 , 2 l 〉$$

This state is an equal superposition over basis states and can be prepared on a quantum computer using standard techniques in time O(log(n)) using elementary gates. Other shadow states can also be prepared efficiently, e.g., shadow states of fermionic product states that contain one or no fermions in each mode, e.g., by changing signs of amplitudes in the above shadow state.

In other implementations the quantum system to be simulated (or whose spectral properties are to be determined) can be a free-boson system. Free boson systems can also be understood as a collection of coupled quantum harmonic oscillators, which are quantum particles evolving under the influence of quadratic potentials. A free-boson system is described by a quadratic Hamiltonian of the form

$$H = {\sum }_{j , k = 1}^{n} {α}_{j k} {b}_{j}^{†} {b}_{k} + {β}_{j k} {b}_{j} {b}_{k} - {\overline{β}}_{j k} {b}_{j}^{†} {b}_{k}^{†}$$

where bⱼ^{†}, bⱼ are bosonic creation and annihilation operators satisfying the canonical commutation relations and αⱼₖ, βⱼₖ are interaction strengths. In contrast to the free-fermion case, the Hilbert space dimension is infinite in the case of free-bosons.

In some implementations the above Hamiltonian can equivalently be described in terms of so-called generalized coordinates which are Hermitian and defined by

$${Q}_{j} = \frac{1}{\sqrt{2}} ( {b}_{j}^{†} + {b}_{j} )$$

and

$${P}_{j} = \frac{i}{\sqrt{2}} ( {b}_{j}^{†} - {b}_{j} ) .$$

In these examples the shadow Hamiltonian can include a matrix of interaction strengths and the set of observables can include the generalized coordinates S={Q₁, P₁, . . . , Qₙ, Pₙ}(or transformed versions thereof, where the transformation ensures that the resulting shadow Hamiltonian is Hermitian). Example shadow states include a bosonic product state where the expectation value of each of the operators Qⱼ is zero and the expectation value of each of the operators Pⱼ is one. The shadow state can then be a superposition state over the n basis states, which can be prepared on a quantum computer using standard techniques in time O(log(n)) using elementary gates, or a state obtained by transforming the superposition state using a free-Boson Hamiltonian.

Alternatively, the set of operators can include a set of quadratic observables where S={OₘO_{m′}}_{1≤m,m′≤M} and each Oₘ is linear in Pⱼ and Q₁. In these examples, the shadow state can be given by |ρ;S [symbol] =Z_{m,m′} [symbol] OₘO_{m′} [symbol] |m,m′ [symbol] /√A.

Other examples include the simulation of Landau-Lifshits dynamics, where the observables in the set of observables generate a Lie algebra h=u(N) of a unitary group of degree N, wherein N represents system size, the simulation of more complex fermionic systems where the observables in the set of observables generate a Lie algebra h=so(2N) of a special unitary group of degree 2N, or the simulation of bosonic systems where the observables in the set of observables generate a Lie algebra h=sp(2N) of a symplectic group of degree 2N. These systems can be fast-forwarded in the Schrödinger picture (improvements in evolution time) but the current approach provides a speedup in the Heisenberg picture where the improvement is in the volume of the system.

### Example Systems and Processes for Performing Time Dynamics

FIG. 1 is a block diagram of an example system 100 for simulating the time evolution of quantum systems with a Lie algebraic structure using a quantum computer. The example system 100 is an example of a system implemented as classical and quantum computer programs on one or more classical computers and quantum computing devices in one or more locations, in which the systems, components, and techniques described herein can be implemented.

The example system 100 includes a quantum computing device 102 in data communication with a classical processor 104. For illustrative purposes, the quantum computing device 102 and classical processor 104 shown in FIG. 1 are illustrated as separate entities, however in some implementations the classical processor 104 may be included in quantum computing device 102. For example, in some implementations the quantum computing device 102 can be directly connected to the classical processor 104. In other implementations, the quantum computing device 102 can be connected to the classical processor 104 through a network, e.g., a local area network (LAN), wide area network (WAN), the Internet, or a combination thereof.

The classical processor 104 includes components for performing classical computation and can be implemented as one or more computer programs, i.e., one or more modules of computer program instructions encoded on a tangible non-transitory storage medium for execution by, or to control the operation of, a data processing apparatus. The computer storage medium can be a machine-readable storage device, a machine-readable storage substrate, a random or serial access memory device, or a combination of one or more of them.

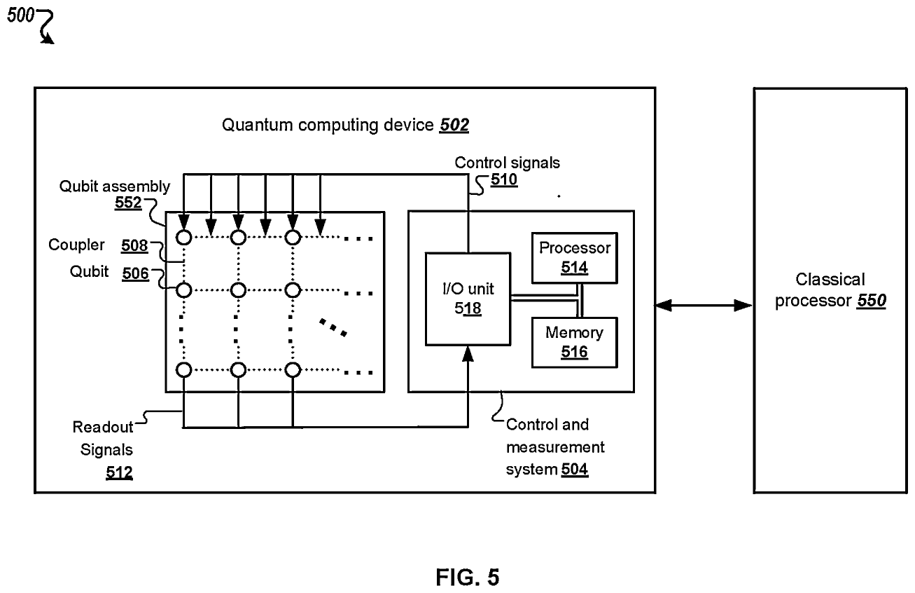

The quantum computing device 102 includes components for performing quantum computation. For example, the quantum computing device 102 can include a qubit array, quantum circuitry, and control devices configured to operate physical qubits in the qubit array and apply quantum circuits to the qubits. In some implementations the quantum computing device 102 can be a fault tolerant device, a noisy device, e.g., a noisy intermediate-scale quantum device (NISQ device), a trapped ion quantum computer, or a neutral atom quantum computer. An example quantum computing device is described in more detail below with reference to FIG. 5.

The classical processor 104 is configured to receive a request 106 to simulate a quantum system. For example, the classical processor 104 can receive a request to perform time dynamics of the quantum system under a first Hamiltonian that characterizes the quantum system, and to compute an expectation value of an observable of interest. In response, the classical processor 104 is configured to determine, e.g., receive as input or retrieve from data storage, a set of observables that include the observable of interest and satisfy Eq. (1) given above. The classical processor 104 is then configured to use the Heisenberg picture for the set of observables to determine a Schrödinger equation on a time dependent vector of coefficients and a second Hamiltonian (shadow Hamiltonian) 108, as described above with reference to Eq. (2) and (3). The classical processor 104 is then configured to transmit data 110 representing the time dependent vector of coefficients and the second Hamiltonian to the quantum computing device 102.

The data 110 instructs the quantum computing device 102 to encode the time dependent vector of coefficients in a quantum state of a register of physical qubits 112 included in the quantum computing device 102 and to simulate time evolution of the encoded time dependent vector of coefficients under the second Hamiltonian 114. In response to receiving the data 110, the quantum computing device 102 is configured to prepare the register of physical qubits 112 in an initial quantum state that encodes the time dependent vector of coefficients and evolve the initial quantum state for a time t under the second Hamiltonian. For example, the quantum computing device 102 can be configured to apply a quantum circuit 116 of quantum logic gates, e.g., gate 118, to the initial quantum state, where application of the quantum circuit evolves the initial quantum state under the second Hamiltonian. By construction, the Hilbert space that the observable of interest acts on can be of size D=exp(M) however, the time dynamics simulation performed by the quantum computing device 102 costs only O(log(M)).

The quantum computing device 102 is then configured to measure 120 the evolved quantum state to obtain a measured value of the observable of interest. As described above, by construction, the measurements of the evolved quantum state (i.e., the physical measurements of the states of the qubits included in the quantum computing device) provide an indirect means of measuring the quantum system to be simulated.

The quantum computing device 102 can repeat this process several times to generate a set of measured observable data 112 that is returned to the classical processor 104. The classical processor 104 is configured to post-process the measured observable data 122 to generate results of the simulation of the quantum system specified in the request 106. For example, the classical processor 104 can use the measured observable data 122 to compute expectation values of the observable 124, e.g., energy levels, and provide the computed expectation value as output 126. Example operations performed by the quantum computing device 102 and classical processor 104 to simulate the time evolution of the example quantum systems described herein are described in more detail below with reference to FIG. 2.

FIG. 2 is a flow diagram of an example process 200 for quantum simulation of the time dynamics of a quantum system. For convenience, the process 200 will be described as being performed by a system of one or more classical and quantum computing devices located in one or more locations. For example, the system 100 of FIG. 1, appropriately programmed, can perform example process 200.

The quantum system is a system that obeys Eq. (1)-(3) above. That is, the quantum system is characterized by a Hamiltonian H (also referred to herein as a first Hamiltonian) and a commutator of each observable in a set of observables with the first Hamiltonian is equal to a linear combination of observables in the set of observables. The weights of the terms in the linear combination of observables are complex-valued and determine an M-dimensional Hermitian matrix X (referred to herein as a second Hamiltonian or shadow Hamiltonian). The first Hamiltonian has a larger dimension than the second Hamiltonian.

In some implementations, the observables in the set of observables generate a Lie algebra. In these implementations, the first Hamiltonian is given by a linear combination of observables in the set of observables (see Eq. (5)) and the second Hamiltonian is given by a complex-valued matrix of real weights in the second linear combination of observables and structure factors of the Lie algebra (see Eq. (6)).

In other implementations, the first Hamiltonian can be an element of a Lie algebra (however time-dependent versions of the observables in the set of observables are not necessarily elements of the Lie algebra). In these implementations the set of observables define a real vector space, and the real vector space is invariant to conjugation of operators that are dependent on the Lie algebra, e.g., operators of the form e^{ih} where h represents the Lie algebra.

In other implementations, the first Hamiltonian can be a free-fermion Hamiltonian or a free-boson Hamiltonian.

The system uses a quantum computer to encode a vector of coefficients of a time-dependent representation of an observable generated from the set of observables in a quantum state of a register of qubits included in the quantum computer (step 202). The observable generated from the set of observables can be an element of the set of observables, e.g., a user-specified Oⱼ of interest, or a product of two or more elements of the set of observables, e.g., a user-specified product OⱼOₖ or OⱼOₖOₗ.

As described above with reference to FIG. 1, in the Heisenberg picture, any time-dependent version Oⱼ(t) of an observable Oⱼ in the set of observables can be written as a linear combination of observables in the set of observables. That is, any time-dependent observable can be expressed as Σⱼ pⱼ(t)Oⱼ, where the pⱼ(t)∈R form the vector of coefficients \vec{p}(t) that is encoded in a quantum state of a register of qubits included in the quantum computer. The vector of coefficients has a dimension M equal to a number of observables included in the set of observables. The register of qubits includes at least ┌log₂M┐ qubits.

To encode the vector of coefficients of the time-dependent representation of the observable in the quantum state of the register of qubits, the system prepares the register of qubits in an initial quantum state that is proportional to the vector of coefficients at an initial time t=0. This state is referred to herein as a shadow state. That is, the system prepares an initial quantum state proportional to \vec{p}(0), which is referred to herein as |\vec{p}(0) [symbol] . In some implementations this quantum state can be prepared with cost poly(n), e.g., using known quantum state preparation techniques. The amplitudes of the initial quantum state can be proportional to an expectation value of the observable with respect to an initial state of the quantum system, e.g.,

$${p}_{j} ( 0 ) = Ψ \vert {O}_{j} ( 0 ) \vert Ψ \qquad ( 10 )$$

where |Ψ [symbol] represents the initial state of the quantum system in the Hilbert space C²^{^{N}}.

The system then uses the quantum computer to simulate time evolution of the initial quantum state |\vec{p}(0) [symbol] under the second Hamiltonian X to obtain an evolved quantum state |\vec{p}(t) [symbol] (step 204). The evolved quantum state is given below in Eq. (24). In other words, using Eq. (1)-(3), the time evolution of the first Hamiltonian H is simulated by simulating time evolution of the vector of coefficients \vec{p}(t) on the quantum computer. This is more computationally efficient than performing a full quantum simulation in the 2^{N}-dimensional space of the first Hamiltonian since dim \vec{p}(t)=M<<2^{N}, e.g., M=poly(N).

The system can perform known techniques to simulate the second Hamiltonian X. In some implementations the second Hamiltonian X can be efficiently simulated for time t with complexity poly(n,t). After the simulation has been performed, the system measures the quantum state of the register of qubits to obtain measurement results (step 206).

The system uses a classical processor to process the measurement results and compute an expectation value of the observable (or product of observables) (step 208). The expectation value of the observable is obtained by computing the vector \vec{p}(t) on the quantum computer at step 204. During the simulation of the second Hamiltonian X, the amplitudes of the evolved quantum state are proportional to a time-dependent expectation value of the observable with respect to an initial state of the quantum system. That is, pⱼ(t)∝ [symbol] Ψ|Oⱼ(t)|Ψ [symbol] so that the amplitudes of the vector \vec{p}(t) encode the time-dependent expectation values.

To see this, consider an eigenvector \vec{v}ₖ of the second Hamiltonian X, corresponding to the operator O_{\vec{v}}_{ₖ}=Σⱼ v_{k,j}Oⱼ where v_{k,j}∈C and O_{\vec{v}}_{ₖ} might not be Hermitian. This operator is then stationary under H, as

$$[ H , {O}_{{\vec{v}}_{k}} ] = {\sum }_{j , l} {v}_{k , j} {h}_{j , l} {O}_{l} = {E}_{{\vec{v}}_{k}} {\sum }_{j} {v}_{k , j} {O}_{j} = {E}_{{\vec{v}}_{k}} {O}_{{\vec{v}}_{k}} \qquad ( 11 )$$

where E_{\vec{v}}_{ₖ} is the eigenvalue of X corresponding to \vec{v}ₖ and k∈[M]. This implies by Eq. (2) that

$${O}_{{\vec{v}}_{k}} ( t ) = {e}^{{itE}_{{\vec{v}}_{k}}} {O}_{{\vec{v}}_{k}} ( 0 ) . \qquad ( 12 )$$

In particular, for any quantum state |Ψ [symbol] ,

$$\begin{matrix}Ψ \vert {e}^{itH} {O}_{{\vec{v}}_{k}} ( 0 ) {e}^{- itH} \vert Ψ = Ψ \vert {O}_{{\vec{v}}_{k}} ( t ) \vert Ψ & ( 13 ) \\ = {e}^{{itE}_{{\vec{v}}_{k}}} Ψ \vert {O}_{{\vec{v}}_{k}} ( 0 ) \vert Ψ . & ( 14 )\end{matrix}$$

Since the second Hamiltonian X is Hermitian, there are M different and orthogonal vectors. It is noted that

$${O}_{{\vec{v}}_{k}} ( t ) = {\sum }_{j} {v}_{k , j} {O}_{j} ( t ) \qquad ( 15 )$$

and, from orthogonality,

$${v}_{k , j} = tr [ {O}_{{\vec{v}}_{k}} ( t ) {O}_{j} ( t ) ] = tr [ {O}_{{\vec{v}}_{k}} ( 0 ) {O}_{j} ( 0 ) ] \qquad ( 16 )$$

This also implies that the M×M matrix of coefficients v_{k,j} is unitary and

$$\begin{matrix}{O}_{j} ( t ) = {\sum }_{k} {( {v}_{j , k} )}^{†} {O}_{{\vec{v}}_{k}} ( t ) & ( 17 ) \\ = {\sum }_{k} {v}_{k , j}^{*} {O}_{{\vec{v}}_{k}} ( t ) . & ( 18 )\end{matrix}$$

Then, for all j∈[M],

$$\begin{matrix}Ψ \vert {O}_{j} ( t ) \vert Ψ = {\sum }_{k} {v}_{k , j}^{*} Ψ \vert {O}_{{\vec{v}}_{k}} ( t ) \vert Ψ & ( 19 ) \\ = {\sum }_{k} {v}_{k , j}^{*} {e}^{{itE}_{{\vec{v}}_{k}}} Ψ \vert {O}_{{\hat{v}}_{k}} ( 0 ) \vert Ψ & ( 20 ) \\ = {\sum }_{k , l} {v}_{k , j}^{*} {e}^{{itE}_{{\vec{v}}_{k}}} {v}_{k , l} Ψ \vert {O}_{l} ( 0 ) \vert Ψ & ( 21 ) \\ = {( {e}^{itX} \vec{p} ( 0 ) )}_{j} & ( 22 ) \\ = {p}_{j} ( t ) . & ( 23 )\end{matrix}$$

Hence, the state computed on the quantum computer at step 204 is

$$\vert \vec{p} ( t ) := {e}^{- itX} \vert \vec{p} ( 0 ) 〉 \qquad ( 24 )$$

and has the property that the inner product [symbol] j|\vec{p}(t) [symbol] =∝pⱼ(t) for all t∈R.
This can be generalized to products of observables Oⱼ as explained above. For example, the below quantity can be calculated

$$\begin{matrix}Ψ \vert {O}_{{j}_{1}} ( t ) {O}_{{j}_{2}} ( t ) \vert Ψ = {\sum }_{{k}_{1} , {k}_{2} , {l}_{1} , {l}_{2}} {v}_{{k}_{1} , {j}_{1}}^{*} {e}^{{itE}_{{\vec{v}}_{{k}_{1}}}} {v}_{{k}_{1} , {t}_{1}} & ( 25 ) \\ {v}_{{k}_{2} , {j}_{2}}^{*} {e}^{{itE}_{{\vec{v}}_{{k}_{2}}}} {v}_{{k}_{2} , {l}_{2}} \times & \\ Ψ \vert {O}_{{l}_{1}} ( 0 ) {O}_{{l}_{2}} ( 0 ) \vert Ψ & ( 26 ) \\ = {\sum }_{{l}_{1} , {l}_{2}} {{[ {e}^{itX} ]}_{{j}_{1} , {l}_{1}} [ {e}^{itX} ]}_{{j}_{2} , {l}_{2}} Ψ \vert {O}_{{t}_{1}} ( 0 ) {O}_{{l}_{2}} ( 0 ) \vert Ψ . & ( 27 )\end{matrix}$$

For some initial quantum states |Ψ [symbol] the matrix [symbol] Ψ|Oⱼ₁(0)Oⱼ₂(0)|Ψ [symbol] can be evaluated [symbol] classically in O(polylog(N)) time and implemented as an additional unitary evolution on the quantum computer, since it regards the evolution under e^{it(X⊗I+I⊗X)}≡e^{itX}⊗e^{itX} where I represents the identity matrix, or a related Hamiltonian that can be efficiently computed. In other words, the vector space V can be chosen so that it includes products such as Oⱼ₁Oⱼ₂, as explained above. The amplitudes of the state |\vec{p}(t)) in this example are proportional to the expectations of the products Oⱼ₁(t)Oⱼ₂(t) in this initial state |Ψ [symbol] . This generalizes to products such as Oⱼ₁Oⱼ₂Oⱼ₃ by now evolving with, for example, e^{it(X⊗I⊗I+I⊗X⊗I+I⊗I⊗X)}≡e^{itX}⊗e^{itX}⊗e^{itX}.

In some implementations, example process 200 can be generalized to encode expectations of products of operators in the amplitudes of a quantum state at step 202. The time-dependent expectation of an operator O in a state ρ(t) can be alternatively described in the Heisenberg picture as the expectation of O(t), the time-dependent operator, in the initial state ρ(0)=ρ. The evolution of the operator is determined by Heisenberg's equations, i.e.,

$$\frac{d}{dt} O ( t ) = i [ {H}_{H} ( t ) , O ( t ) ] ,$$

where H_{H}(t) is the Hamiltonian in the Heisenberg picture. More generally, products of time-evolving operators, e.g., O₁(t)O₂(t), where each operator evolves according to its own Hamiltonian, e.g., H₁(t) and H₂(t), respectively, can be considered.

In some implementations, example process 200 can encode time-evolved operators in the Heisenberg picture in the shadow state, rather than their expectations, at step 202. For example, for a set of operators S={O₁, . . . , Oₘ} and any one operator of the form Z=Σₘ₌₁^{M} zₘOₘ where zₘ is a complex coefficient, the corresponding operator in the Heisenberg picture is Z(t)=Σₘ₌₁^{M} zₘOₘ (t) where Oₘ(t) satisfies Heisenberg's equations of motion determined by the Hamiltonian H. Under the invariance property described with reference to Equations (1)-(3), the evolution of Z(s)=Σₘ₌₁^{M} zₘOₘ (s) can be considered, where Oₘ(s) are defined as Oₘ(s):=(U(t,t−s))^{†}OₘU(t,t−s) for all m∈|M}, where U(t,t′) represents is the evolution induced by the Hamiltonian from time t′ to time t≥t′ (that is the operators Oₘ(s) are not operators in the Heisenberg picture). Because of the invariance property, the evolution Z(s) can also be written Z(s)=Σₘ₌₁^{M} zₘ(s)Oₘ for complex valued zₘ(s). The corresponding operator-to-state mapping is therefore

$$Z ( s ) \vert Z ( s ) := \frac{1}{√ A} {\sum }_{m = 1}^{M} {\overline{z}}_{m} ( s ) \vert m 〉$$

where A is a normalization constant. It can be shown that evolution of the state |Z(s) [symbol] is given by a Schrödinger equation if the corresponding shadow Hamiltonian is Hermitian. The encoding given by the above operator-to-state mapping provides a quantum algorithm to track the evolution of Z(s), which coincides with the time-evolved operator in the Heisenberg picture when s=t. Applications of these implementations include operator scrambling, e.g., observing the growth of a light cone associated with some final observable, as it is brought to the start of the evolution. For example, the Hamming weight of the operator Z(t) could be related with an observable that can be directly measured in |Z(t) [symbol] . Another potential application concerns performing full quantum state tomography on |Z(t) [symbol] to later compute, offline, the expectation [symbol] Z(t) [symbol] on a given state ρ.

### Example Systems and Processes for Spectral and Response Functions

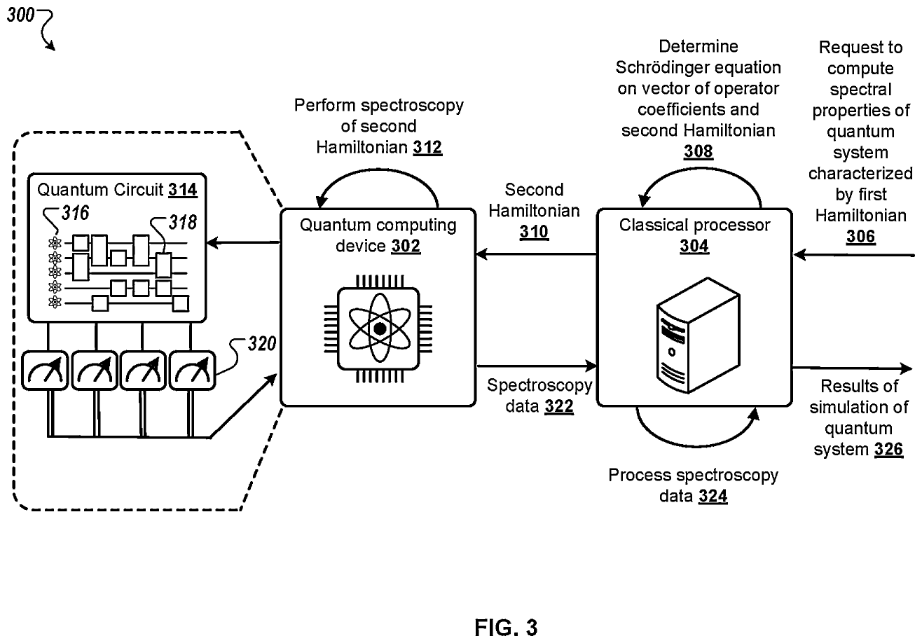

FIG. 3 is a block diagram of an example system 300 for computing spectral properties (e.g., energy levels) of quantum systems with a Lie algebraic structure using a quantum computer. The example system 300 is an example of a system implemented as classical and quantum computer programs on one or more classical computers and quantum computing devices in one or more locations, in which the systems, components, and techniques described herein can be implemented.

The example system 300 includes a quantum computing device 302 in data communication with a classical processor 304. For illustrative purposes, the quantum computing device 302 and classical processor 304 shown in FIG. 3 are illustrated as separate entities, however in some implementations the classical processor 304 may be included in quantum computing device 302. For example, in some implementations the quantum computing device 302 can be directly connected to the classical processor 304. In other implementations, the quantum computing device 302 can be connected to the classical processor 304 through a network, e.g., a local area network (LAN), wide area network (WAN), the Internet, or a combination thereof.

The classical processor 304 includes components for performing classical computation and can be implemented as one or more computer programs, i.e., one or more modules of computer program instructions encoded on a tangible non-transitory storage medium for execution by, or to control the operation of, a data processing apparatus. The computer storage medium can be a machine-readable storage device, a machine-readable storage substrate, a random or serial access memory device, or a combination of one or more of them.

The quantum computing device 302 includes components for performing quantum computation. For example, the quantum computing device 302 can include a qubit array, quantum circuitry, and control devices configured to operate physical qubits in the qubit array and apply quantum circuits to the qubits. In some implementations the quantum computing device 302 can be a fault tolerant device, a noisy device, e.g., a noisy intermediate-scale quantum device (NISQ device), a trapped ion quantum computer, or a neutral atom quantum computer. An example quantum computing device is described in the more detail below with reference to FIG. 5.

The classical processor 304 is configured to receive a request 306 to simulate a quantum system. For example, the classical processor 304 can receive a request to compute spectral properties of a quantum system that is characterized by a first Hamiltonian, e.g., eigenvalues and eigenvectors of the first Hamiltonian (which can correspond to energy levels of the quantum system). In response, the classical processor 304 is configured to determine, e.g., receive as input or retrieve from data storage, a set of observables that include the observable of interest and satisfy Eq. (1) given above. The classical processor 304 is then configured to use the Heisenberg picture for the set of observables to determine a Schrödinger equation on a time dependent vector of coefficients and a second Hamiltonian 308, as described above with reference to Eq. (2) and (3). The classical processor 304 is then configured to transmit data 310 representing the second Hamiltonian to the quantum computing device 302.

The data 310 instructs the quantum computing device 302 to perform spectroscopy of the second Hamiltonian 312, e.g., using quantum circuitry 314 such as physical qubits 316, quantum logic gates 318, and measurements 320. For example, the quantum computing device 302 can perform a kernel polynomial method to perform spectroscopy of the second Hamiltonian 312. The quantum computing device 302 is then configured to return a set of spectroscopy data 322 to the classical processor 304.

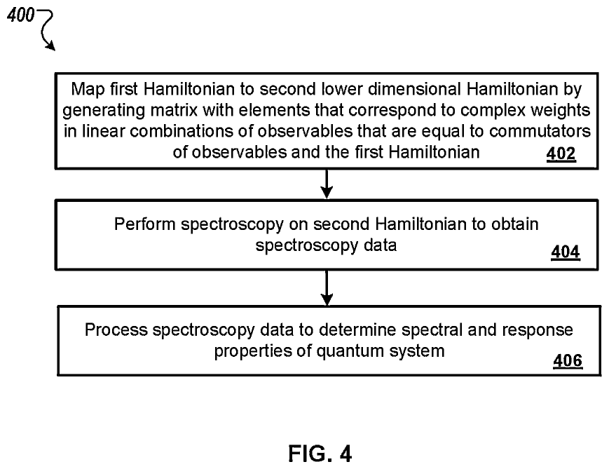

The classical processor 304 is configured to process 324 the spectroscopy data 322 to generate results of the simulation of the quantum system specified in the request 306. Example operations performed by the quantum computing device 302 and classical processor 304 to compute spectral properties of a quantum system are described herein are described in more detail below with reference to FIG. 4.

FIG. 4 is a flow diagram of an example process 400 for computing spectral properties of a quantum system. For convenience, the process 400 will be described as being performed by a system of one or more classical and quantum computing devices located in one or more locations. For example, the system 100 of FIG. 1, appropriately programmed, can perform example process 400.

The quantum system is a system that obeys Eq. (1) above. That is, the quantum system is characterized by a Hamiltonian H (also referred to herein as a first Hamiltonian) and a commutator of each observable in a set of observables with the first Hamiltonian is equal to a linear combination of observables in the set of observables. The weights of the terms in the linear combination of observables are complex-valued and determine an M-dimensional Hermitian matrix X (referred to herein as a second Hamiltonian). The first Hamiltonian has a larger dimension than the second Hamiltonian.

In some implementations, the observables in the set of observables generate a Lie algebra. In these implementations, the first Hamiltonian is given by a linear combination of observables in the set of observables (see Eq. (5)) and the second Hamiltonian is given by a complex-valued matrix of real weights in the second linear combination of observables and structure factors of the Lie algebra (see Eq. (6)).

In other implementations, the first Hamiltonian can be an element of a Lie algebra (however time-dependent versions of the observables in the set of observables are not necessarily elements of the Lie algebra). In these implementations the set of observables define a real vector space, and the real vector space is invariant to conjugation of operators that are dependent on the Lie algebra, e.g., operators of the form e^{ih} where h represents the Lie algebra.

The system uses a classical processor to map the first Hamiltonian to a second Hamiltonian with lower dimension than the first Hamiltonian (step 402). To implement the mapping, the system generates a matrix wherein elements of the matrix correspond to respective complex weights in the linear combinations of observables. That is, the system generates the matrix X using the coefficients h_{j,k} as described above with reference to Eq. (1).

By construction, spectral and response properties of the first Hamiltonian H can be analyzed by studying the spectral properties of the second Hamiltonian X alone, as detailed below. Therefore, the system uses a quantum computer to perform spectroscopy on the second Hamiltonian to obtain spectroscopy data (step 404).

The commutator rule (Eq. (11)) implies that each observable O_{\vec{v}}_{ₖ} acts as a permutation operator on a subset of eigenstates of H. Note that O_{\vec{v}}_{ₖ} is not necessarily an observable. Suppose that |Ψ [symbol] is an eigenstate of H, i.e. H|Ψ [symbol] =E|Ψ [symbol] . Then,

$${HO}_{{\vec{v}}_{k}} \vert Ψ = {O}_{{\vec{v}}_{k}} H \vert Ψ + [ H , {O}_{{\vec{v}}_{k}} ] \vert Ψ = ( E + {E}_{{\vec{v}}_{k}} ) {O}_{{\vec{v}}_{k}} \vert Ψ . \qquad ( 28 )$$

This implies that, given an initial eigenstate |Ψ [symbol] ≡|vac [symbol] , the additional eigenstates can be generated by the action of different O_{\vec{v}}_{ₖ}:

$$\vert {\vec{v}}_{{k}_{1}} , {\vec{v}}_{{k}_{2}} , … := \frac{1}{{Z}_{{\vec{v}}_{{k}_{1}} , {\vec{v}}_{{k}_{2}} , …}} {O}_{{\vec{v}}_{{k}_{1}}} {O}_{{\vec{v}}_{{k}_{2}}} … \vert vac , \qquad ( 29 )$$

$$H \vert {\vec{v}}_{{k}_{1}} , {\vec{v}}_{{k}_{2}} , … = ( {E}_{vac} + {E}_{{\vec{v}}_{{k}_{1}}} + {E}_{{\vec{v}}_{{k}_{1}}} + {E}_{{\vec{v}}_{{k}_{2}}} + … ) \vert {\vec{v}}_{{k}_{1}} , {\vec{v}}_{{k}_{2}} , … , \qquad ( 30 )$$

where Z_{\vec{v}}_{ₖ₁}_{,\vec{v}}_{_{k2, . . .}} is a normalization constant. For Lie algebras with a Cartan-Weyl decomposition, |vac [symbol] is usually the lowest-weight state. Let v=(\vec{v}ₖ₁, \vec{v}ₖ₂, . . . ) be used as shorthand for the labels of the eigenstates and append from the left via concatenation (\vec{v}ₖ₁+v). O_{\vec{v}}_{ₖ} may annihilate a state O_{\vec{v}}_{ₖ}|v [symbol] =0, which will render some of the above label invalid. For example, if O_{\vec{v}}_{ₖ}=aₖ^{†} (Eq. (9)), where this refers to a fermion or a hard-core boson,

$${O}_{{v}_{k}}^{2} = 0 , and {O}_{{v}_{k}} \vert v 〉 = 0 if {v}_{k} ∈ v .$$

Moreover, O_{\vec{v}}_{ₖ}|v [symbol] =|v [symbol] can occur if [H, O_{\vec{v}}_{ₖ}]=0, which would be the case for e.g. a number operator aₖ^{†}aₖ if H preserves the number, or O_{\vec{v}}_{₁}O_{\vec{v}}_{₂}|v [symbol] =e^{iϕ}O_{\vec{v}}_{₁}O_{\vec{v}}_{₂}|v [symbol] may occur. In both cases, some states |v₁ [symbol] , |v₂ [symbol] may be equivalent. These rules are determined by investigating the commutator structure of the Lie algebra, and do not require knowing in advance the precise form of the O_{\vec{v}}_{ₖ}. For this case it can be assumed that the relevant set of observables {Oⱼ}ⱼ is indeed a basis of the Lie algebra h.

The operators O_{\vec{v}}_{ₖ} are usually referred to as raising/lowering or ladder operators. As the spectrum of the second Hamiltonian X corresponds to gaps between eigenstates of the first Hamiltonian H, negative eigenvalues of the second Hamiltonian X correspond to operators O_{\vec{v}} that destroy the ground state of the first Hamiltonian H. Positive eigenvalues of the second Hamiltonian X that do not annihilate the ground state correspond to allowed excitations. This implies that if the system is coupled to an external field with a coupling of the form a^{†}Oⱼ+aOⱼ^{†}, the eigen-decomposition of |j [symbol] in the basis of the second Hamiltonian X above (below) zero energy will contain the observed absorption (emission) spectrum. Often the observed spectra will be summed over multiple operators Oⱼ, but in some cases it may be spatially resolvable; e.g. angular-resolved photoemission spectroscopy (ARPES) can couple to creation operators cₖ^{†} of fixed momentum k. Localized excitations due to either Anderson localization or symmetry-protected topological order can also be identified.

Expectation values of eigenstates of the first Hamiltonian H can be learned from the structure of the algebra h, as the latter contains the operators O_{\vec{v}}_{ₖ} and the eigenvalues E_{\vec{v}}_{ₖ} can be obtained. For example, the expectation value of an operator Oⱼ on an eigenstate |v [symbol] can be calculated from its spectral decomposition as

$$𝔳 \vert {O}_{J} \vert 𝔳 = {\sum }_{k} {υ}_{k , j}^{*} 〈 𝔳 \vert {O}_{{\vec{v}}_{k}} \vert 𝔳 〉 \qquad ( 31 )$$

$$= {\sum }_{k} {υ}_{k , j}^{*} 〈 𝔳 \vert {\vec{υ}}_{k} + 𝔳 〉 \qquad ( 32 )$$

$$= {\sum }_{k : {E}_{{\vec{v}}_{k}} = 0} {υ}_{k , j}^{*} 〈 𝔳 \vert {\vec{υ}}_{k} + 𝔳 〉 , \qquad ( 33 )$$

where the fact that if |, \vec{v}ₖ₁, . . . [symbol] ≡|\vec{v}ₖ₁, . . . [symbol] , then E_{\vec{v}}_{ₖ}=0. This implies that the below quantity can be bounded

$$\vert k \vert {O}_{j} {\vert k \vert}^{2} \leq 〈 j \vert {Π}_{0} \vert j 〉 , \qquad ( 34 )$$

where the right-hand is worked in the space of the Lie algebra operators, and Π₀ is the projector onto the 0-energy space. The right-hand side can be measured by energy-resolved spectroscopy of |j [symbol] .

As another short example which is more common in condensed matter, consider a state that is diagonal in the energy basis of the first Hamiltonian H

[symbol]

$$ρ = {\sum }_{v} {p}_{v} \vert v v \vert \qquad ( 35 )$$

$$Trace [ {ρO}_{j 1}^{†} {O}_{j 2} ] = {\sum }_{𝔳} {p}_{𝔳} 〈 𝔳 \vert {O}_{j 1}^{†} {O}_{j 2} \vert 𝔳 〉 \qquad ( 36 )$$

$$= {\sum }_{𝔳 , k , k ′} {υ}_{j 1 , k} {υ}_{k , {j}_{2}}^{*} 〈 𝔳 \vert {O}_{{\vec{v}}_{k}}^{†} {O}_{{\vec{v}}_{k ′}} \vert 𝔳 〉 \qquad ( 37 )$$

$$= {\sum }_{𝔳 , k , k ′ {E}_{{\vec{v}}_{k}} = {E}_{{\vec{v}}_{k ′}}} {υ}_{j 1 , k} {υ}_{k , {j}_{2}}^{*} 〈 {\vec{υ}}_{k} + 𝔳 \vert {\vec{υ}}_{k ′} + 𝔳 〉 . \qquad ( 38 )$$

Note that if the spectrum of the second Hamiltonian X is non-degenerate, this forces \vec{v}ₖ=\vec{v}_{k′}. This can be forced on more general grounds, if [symbol] \vec{v}_{k′}+v [symbol] =δ_{k,k′}n_{k,v} where

[symbol]

$${n}_{k , v} = v \vert {O}_{{\vec{v}}_{k}}^{†} {O}_{{\vec{v}}_{k}} \vert v \qquad ( 39 )$$

$$〈 𝔳 \vert {O}_{j 1}^{†} {O}_{j 2} \vert 𝔳 〉 = {\sum }_{k} {υ}_{{j}_{1} , k} {n}_{k , 𝔳} {υ}_{k , {j}_{2}}^{*} . \qquad ( 40 )$$

$$Trace [ {ρO}_{j 1}^{†} {O}_{j 2} ] = {\sum }_{k} {υ}_{{j}_{1} , k} {f}_{k}^{( ρ )} {υ}_{k , {j}_{2}}^{*} , \qquad ( 41 )$$

$${f}_{k}^{( ρ )} = {\sum }_{𝔳} {p}_{𝔳} {n}_{k , 𝔳} . \qquad ( 42 )$$

The above can be estimated by spectroscopy of the second Hamiltonian X. For example, if Oⱼ=cⱼ are annihilation operators, this allows thermal expectation values for fermions or bosons at inverse temperature β to be calculated by setting

$${f}_{k}^{( ρ )} = \frac{1}{{e}^{β ( {E}_{{\vec{υ}}_{k}} - μ )} \pm 1} . \qquad ( 43 )$$

The quantum advantage in this case is the evaluation of v_{j,k}, which corresponds on the device to an amplitude [symbol] \vec{v}ₖ|j [symbol] between an eigenstate |\vec{v}ₖ [symbol] and a computational basis state |j [symbol] . This can also be encoded as an expectation value,

$${\sum }_{k} υ {\vert}_{j 1 , k ,} {f}_{k}^{ρ} {υ}_{k , j 2}^{*} = {j}_{1} \vert ( {\sum }_{k} \vert k 〉 {f}_{k}^{ρ} 〈 k \vert ) \vert {j}_{2} \qquad ( 44 )$$

$$= 〈 {j}_{1} \vert {F}^{ρ} \vert {j}_{2} 〉 , \qquad ( 45 )$$

where F^{ρ}=Σₖ ƒₖ^{ρ}|k [symbol] [symbol] k| is a diagonal operator in the eigenbasis of the second Hamiltonian

The above shows spectral properties of the first Hamiltonian H can be analyzed by studying the spectral properties of the second Hamiltonian X alone. In cases where L<<2N, this can result in an exponential cost savings.

In some implementations, in order to perform spectroscopy on the second Hamiltonian, the system can implement a kernel polynomial method (KPM) as a quantum algorithm. The KPM is a classical routine. To implement it requires the decomposition of a function ƒ(x), x∈R, in terms of Chebyshev polynomials of x

$$π \sqrt{1 - {x}_{k}^{2}} f ( {x}_{k} ) \approx {μ}_{0} {g}_{0} + 2 {\sum }_{n = 1}^{N - 1} {μ}_{n} {g}_{n} cos ( \frac{π n ( k + 1 / 2 )}{N} ) . \qquad ( 46 )$$

For these problems, x is typically the energy of a quantum system, Tₙ(x) is the n-th Chebyshev polynomial of the first kind, xₖ are a fixed set of reduced points, and gₙ are kernel coefficients.
For certain choices of ƒ(x), the coefficients μₙ correspond to functions of Chebyshev polynomials of the second Hamiltonian X

$${μ}_{n} = i \vert {T}_{n} ( X ) \vert j . \qquad ( 48 )$$

As an example, the local density of states

$${ρ}_{i} ( E ) = \frac{1}{D} {\sum }_{k = 0}^{D - 1} {\vert k \vert}^{2} δ ( E - {E}_{k} ) , \qquad ( 49 )$$

which is equivalent to Eq. (40) with j₁=j₂ and n_{k,v}=δ(E−Eₖ), can be encoded in the above form with

$${μ}_{n} = \frac{1}{D} i \vert {T}_{n} ( X ) \vert i . \qquad ( 50 )$$

The form of the moments μₙ extends by linearity to ƒ(x): the case of Eq. (47) gives

$$π \sqrt{1 - {x}_{k}^{2}} f ( {x}_{k} ) = Trace [ {AF}_{x} ( X ) B ] , \qquad ( 51 )$$

while the case of Eq. (48) gives

$$π \sqrt{1 - {x}_{k}^{2}} f ( {x}_{k} ) \approx 〈 i \vert {F}_{k} ( X ) \vert j 〉 . \qquad ( 52 )$$

where in both cases

$${F}_{k} ( X ) = {T}_{0} ( X ) {g}_{0} + 2 {\sum }_{n = 1}^{N - 1} {T}_{n} ( X ) {g}_{n} cos ( \frac{π n ( k + 1 / 2 )}{N} ) .$$

In some implementations the system can encode the operator F(X) on a quantum computer via linear combination of unitaries approximations and quantum signal processing, and then estimate matrix elements of F(X) at the Heisenberg limit using a known method or algorithm. This can be implemented using a block encoding of the second Hamiltonian X. If this has O(polylog(N)) cost, the algorithm will have an exponential improvement over classical algorithms in the most general case.

In some implementations, example process 400 can be used to compute the local density of states of graphene under the presence of local disorder, e.g., to measure the effect of Anderson localization. In these implementations the system can obtain, e.g., determine, quantum circuits that encode the second Hamiltonian X for a hexagonal lattice with local disorder, and use these as a sub-block of an outer quantum signal processing routine to construct F(X) (as given in Eq. (53)) as a sum of Chebyshev polynomials Tₙ(X). The system can then execute these circuits on the quantum computer to estimate expectation values ρᵢ(Eₖ)= [symbol] i|Fₖ (X)|i [symbol] , where i indexes the site of interest. This could be achieved at the Heisenberg limit by using the expectation value estimation algorithm. This immediately allows for the estimation of the density of states at a fixed energy Eₖ. In some implementations the density of states at a temperature T can be computed by performing the integration

$${\int }_{- ‖ X ‖}^{‖ X ‖} dE {ρ}_{i} ( E ) \frac{1}{e \frac{E - μ}{T} + 1} \qquad ( 54 )$$

by discretizing over the calculated points Eₖ. Here, the second term in the equation is the Fermi-Dirac distribution, which is equivalent to Eq. (43) under relabeling and a choice of a + sign.

The system uses the classical processor to process the spectroscopy data to determine spectral and response properties of the quantum system (step 406).

FIG. 5 depicts an example classical-quantum computing system 500 for performing some or all of the classical and quantum operations described in this specification. The example computing system 500 includes an example quantum computing device 502. The quantum computing device 502 is intended to represent various forms of quantum computing devices. The components shown here, their connections and relationships, and their functions, are exemplary only, and do not limit implementations of the inventions described and/or claimed in this document.

The example quantum computing device 502 includes a qubit assembly 552 and a control and measurement system 504. The qubit assembly includes multiple qubits, e.g., qubit 506, that are used to perform algorithmic operations or quantum computations. While the qubits shown in FIG. 5 are arranged in a rectangular array, this is a schematic depiction and is not intended to be limiting. The qubit assembly 552 also includes adjustable coupling elements, e.g., coupler 508, that allow for interactions between coupled qubits. In the schematic depiction of FIG. 5, each qubit is adjustably coupled to each of its four adjacent qubits by means of respective coupling elements. However, this is an example arrangement of qubits and couplers, and other arrangements are possible, including arrangements that are non-rectangular, arrangements that allow for coupling between non-adjacent qubits, and arrangements that include adjustable coupling between more than two qubits.

Each qubit can be a physical two-level quantum system or device having levels representing logical values of 0 and 1. The specific physical realization of the multiple qubits and how they interact with one another is dependent on a variety of factors including the type of the quantum computing device 502 included in the example computing system 500 or the type of quantum computations that the quantum computing device is performing. For example, in an atomic quantum computer the qubits may be realized via atomic, molecular or solid-state quantum systems, e.g., hyperfine atomic states. As another example, in a superconducting quantum computer the qubits may be realized via superconducting qubits or semi-conducting qubits, e.g., superconducting transmon states. As another example, in a NMR quantum computer the qubits may be realized via nuclear spin states.

In some implementations a quantum computation can proceed by loading qubits, e.g., from a quantum memory, and applying a sequence of unitary operators to the qubits. Applying a unitary operator to the qubits can include applying a corresponding sequence of quantum logic gates to the qubits, e.g., to implement a quantum algorithm such as a quantum principle component algorithm. Example quantum logic gates include single-qubit gates, e.g., Pauli-X, Pauli-Y, Pauli-Z (also referred to as X, Y, Z), Hadamard gates, S gates, rotations, two-qubit gates, e.g., controlled-X, controlled-Y, controlled-Z (also referred to as CX, CY, CZ), controlled NOT gates (also referred to as CNOT) controlled swap gates (also referred to as CSWAP), and gates involving three or more qubits, e.g., Toffoli gates. The quantum logic gates can be implemented by applying control signals 510 generated by the control and measurement system 504 to the qubits and to the couplers.

For example, in some implementations the qubits in the qubit assembly 552 can be frequency tunable. In these examples, each qubit can have associated operating frequencies that can be adjusted through application of voltage pulses via one or more drive-lines coupled to the qubit. Example operating frequencies include qubit idling frequencies, qubit interaction frequencies, and qubit readout frequencies. Different frequencies correspond to different operations that the qubit can perform. For example, setting the operating frequency to a corresponding idling frequency may put the qubit into a state where it does not strongly interact with other qubits, and where it may be used to perform single-qubit gates. As another example, in cases where qubits interact via couplers with fixed coupling, qubits can be configured to interact with one another by setting their respective operating frequencies at some gate-dependent frequency detuning from their common interaction frequency. In other cases, e.g., when the qubits interact via tunable couplers, qubits can be configured to interact with one another by setting the parameters of their respective couplers to enable interactions between the qubits and then by setting the qubit's respective operating frequencies at some gate-dependent frequency detuning from their common interaction frequency. Such interactions may be performed in order to perform multi-qubit gates.

The type of control signals 510 used depends on the physical realizations of the qubits. For example, the control signals may include RF or microwave pulses in an NMR or superconducting quantum computer system, or optical pulses in an atomic quantum computer system.

A quantum computation can be completed by measuring the states of the qubits, e.g., using a quantum observable such as X or Z, using respective control signals 510. The measurements cause readout signals 512 representing measurement results to be communicated back to the measurement and control system 504. The readout signals 512 may include RF, microwave, or optical signals depending on the physical scheme for the quantum computing device and/or the qubits. For convenience, the control signals 510 and readout signals 512 shown in FIG. 5 are depicted as addressing only selected elements of the qubit assembly (i.e. the top and bottom rows), but during operation the control signals 510 and readout signals 512 can address each element in the qubit assembly 552.

The control and measurement system 504 is an example of a classical computer system that can be used to perform various operations on the qubit assembly 552, as described above, as well as other classical subroutines or computations. The control and measurement system 504 includes one or more classical processors, e.g., classical processor 514, one or more memories, e.g., memory 516, and one or more I/O units, e.g., I/O unit 518, connected by one or more data buses. The control and measurement system 504 can be programmed to send sequences of control signals 510 to the qubit assembly, e.g. to carry out a selected series of quantum gate operations, and to receive sequences of readout signals 512 from the qubit assembly, e.g. as part of performing measurement operations.

The processor 514 is configured to process instructions for execution within the control and measurement system 504. In some implementations, the processor 514 is a single-threaded processor. In other implementations, the processor 514 is a multi-threaded processor. The processor 514 is capable of processing instructions stored in the memory 516.

The memory 516 stores information within the control and measurement system 504. In some implementations, the memory 516 includes a computer-readable medium, a volatile memory unit, and/or a non-volatile memory unit. In some cases, the memory 516 can include storage devices capable of providing mass storage for the system 504, e.g. a hard disk device, an optical disk device, a storage device that is shared over a network by multiple computing devices (e.g., a cloud storage device), and/or some other large capacity storage device.

The input/output device 518 provides input/output operations for the control and measurement system 504. The input/output device 518 can include D/A converters, A/D converters, and RF/microwave/optical signal generators, transmitters, and receivers, whereby to send control signals 510 to and receive readout signals 512 from the qubit assembly, as appropriate for the physical scheme for the quantum computer. In some implementations, the input/output device 518 can also include one or more network interface devices, e.g., an Ethernet card, a serial communication device, e.g., an RS-232 port, and/or a wireless interface device, e.g., an 802.11 card. In some implementations, the input/output device 518 can include driver devices configured to receive input data and send output data to other external devices, e.g., keyboard, printer, and display devices.

Although an example control and measurement system 504 has been depicted in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them.

The example computing system 500 also includes an example classical processor 550. The classical processor 550 can be used to perform classical computation operations described in this specification according to some implementations.

Implementations of the subject matter and operations described in this specification can be implemented in digital electronic circuitry, analog electronic circuitry, suitable quantum circuitry or, more generally, quantum computational systems, in tangibly-embodied software or firmware, in computer hardware, including the structures disclosed in this specification and their structural equivalents, or in combinations of one or more of them. The term “quantum computational systems” may include, but is not limited to, quantum computers, quantum information processing systems, quantum cryptography systems, or quantum simulators.

Implementations of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, one or more qubits, or a combination of one or more of them. Alternatively, or in addition, the program instructions can be encoded on an artificially-generated propagated signal that is capable of encoding digital and/or quantum information, e.g., a machine-generated electrical, optical, or electromagnetic signal, that is generated to encode digital and/or quantum information for transmission to suitable receiver apparatus for execution by a data processing apparatus.

The terms quantum information and quantum data refer to information or data that is carried by, held or stored in quantum systems, where the smallest non-trivial system is a qubit, i.e., a system that defines the unit of quantum information. It is understood that the term “qubit” encompasses all quantum systems that may be suitably approximated as a two-level system in the corresponding context. Such quantum systems may include multi-level systems, e.g., with two or more levels. By way of example, such systems can include atoms, electrons, photons, ions or superconducting qubits. In many implementations the computational basis states are identified with the ground and first excited states, however it is understood that other setups where the computational states are identified with higher level excited states are possible.

The term “data processing apparatus” refers to digital and/or quantum data processing hardware and encompasses all kinds of apparatus, devices, and machines for processing digital and/or quantum data, including by way of example a programmable digital processor, a programmable quantum processor, a digital computer, a quantum computer, multiple digital and quantum processors or computers, and combinations thereof. The apparatus can also be, or further include, special purpose logic circuitry, e.g., an FPGA (field programmable gate array), an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus can optionally include, in addition to hardware, code that creates an execution environment for digital and/or quantum computer programs, e.g., code that constitutes processor firmware, a protocol stack, a database management system, an operating system, or a combination of one or more of them.

A digital computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. A quantum computer program, which may also be referred to or described as a program, software, a software application, a module, a software module, a script, or code, can be written in any form of programming language, including compiled or interpreted languages, or declarative or procedural languages, and translated into a suitable quantum programming language, or can be written in a quantum programming language, e.g., QCL or Quipper.

A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a digital and/or quantum data communication network. A quantum data communication network is understood to be a network that may transmit quantum data using quantum systems, e.g. qubits. Generally, a digital data communication network cannot transmit quantum data, however a quantum data communication network may transmit both quantum data and digital data.

The processes and logic flows described in this specification can be performed by one or more programmable computers, operating with one or more processors, as appropriate, executing one or more computer programs to perform functions by operating on input data and generating output. The processes and logic flows can also be performed by, and apparatus can also be implemented as, special purpose logic circuitry, e.g., an FPGA or an ASIC, or a quantum simulator, or by a combination of special purpose logic circuitry or quantum simulators and one or more programmed digital and/or quantum computers.

For a system of one or more computers to be “configured to” perform particular operations or actions means that the system has installed on its software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. For example, a quantum computer may receive instructions from a digital computer that, when executed by the quantum computing apparatus, cause the apparatus to perform the operations or actions.

Computers suitable for the execution of a computer program can be based on general or special purpose processors, or any other kind of central processing unit. Generally, a central processing unit will receive instructions and data from a read-only memory, a random access memory, or quantum systems suitable for transmitting quantum data, e.g. photons, or combinations thereof.

The elements of a computer include a central processing unit for performing or executing instructions and one or more memory devices for storing instructions and digital, analog, and/or quantum data. The central processing unit and the memory can be supplemented by, or incorporated in, special purpose logic circuitry or quantum simulators. Generally, a computer will also include, or be operatively coupled to receive data from or transfer data to, or both, one or more mass storage devices for storing data, e.g., magnetic, magneto-optical disks, optical disks, or quantum systems suitable for storing quantum information. However, a computer need not have such devices.

Quantum circuit elements (also referred to as quantum computing circuit elements) include circuit elements for performing quantum processing operations. That is, the quantum circuit elements are configured to make use of quantum-mechanical phenomena, such as superposition and entanglement, to perform operations on data in a non-deterministic manner. Certain quantum circuit elements, such as qubits, can be configured to represent and operate on information in more than one state simultaneously. Examples of superconducting quantum circuit elements include circuit elements such as quantum LC oscillators, qubits (e.g., flux qubits, phase qubits, or charge qubits), and superconducting quantum interference devices (SQUIDs) (e.g., RF-SQUID or DC-SQUID), among others.

In contrast, classical circuit elements generally process data in a deterministic manner. Classical circuit elements can be configured to collectively carry out instructions of a computer program by performing basic arithmetical, logical, and/or input/output operations on data, in which the data is represented in analog or digital form. In some implementations, classical circuit elements can be used to transmit data to and/or receive data from the quantum circuit elements through electrical or electromagnetic connections. Examples of classical circuit elements include circuit elements based on CMOS circuitry, rapid single flux quantum (RSFQ) devices, reciprocal quantum logic (RQL) devices and ERSFQ devices, which are an energy-efficient version of RSFQ that does not use bias resistors.

In certain cases, some or all of the quantum and/or classical circuit elements may be implemented using, e.g., superconducting quantum and/or classical circuit elements. Fabrication of the superconducting circuit elements can entail the deposition of one or more materials, such as superconductors, dielectrics and/or metals. Depending on the selected material, these materials can be deposited using deposition processes such as chemical vapor deposition, physical vapor deposition (e.g., evaporation or sputtering), or epitaxial techniques, among other deposition processes. Processes for fabricating circuit elements described herein can entail the removal of one or more materials from a device during fabrication. Depending on the material to be removed, the removal process can include, e.g., wet etching techniques, dry etching techniques, or lift-off processes. The materials forming the circuit elements described herein can be patterned using known lithographic techniques (e.g., photolithography or e-beam lithography).

During operation of a quantum computational system that uses superconducting quantum circuit elements and/or superconducting classical circuit elements, such as the circuit elements described herein, the superconducting circuit elements are cooled down within a cryostat to temperatures that allow a superconductor material to exhibit superconducting properties. A superconductor (alternatively superconducting) material can be understood as material that exhibits superconducting properties at or below a superconducting critical temperature. Examples of superconducting material include aluminum (superconductive critical temperature of 1.2 kelvin) and niobium (superconducting critical temperature of 9.3 kelvin). Accordingly, superconducting structures, such as superconducting traces and superconducting ground planes, are formed from material that exhibits superconducting properties at or below a superconducting critical temperature.

In certain implementations, control signals for the quantum circuit elements (e.g., qubits and qubit couplers) may be provided using classical circuit elements that are electrically and/or electromagnetically coupled to the quantum circuit elements. The control signals may be provided in digital and/or analog form.

Computer-readable media suitable for storing computer program instructions and data include all forms of non-volatile digital and/or quantum memory, media and memory devices, including by way of example semiconductor memory devices, e.g., EPROM, EEPROM, and flash memory devices; magnetic disks, e.g., internal hard disks or removable disks; magneto-optical disks; CD-ROM and DVD-ROM disks; and quantum systems, e.g., trapped atoms or electrons. It is understood that quantum memories are devices that can store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, can be implemented in a computer program product that includes instructions that are stored on one or more non-transitory machine-readable storage media, and that are executable on one or more processing devices. The systems described in this specification, or portions of them, can each be implemented as an apparatus, method, or system that may include one or more processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method for quantum simulation of a quantum system characterized by a first Hamiltonian, the method comprising:
for an observable generated from a set of observables, wherein a commutator of each observable in the set of observables with the first Hamiltonian is equal to a linear combination of observables in the set of observables:
encoding, by a quantum computer, a vector of coefficients of a time-dependent representation of the observable in a quantum state of a register of qubits included in the quantum computer;
simulating, by the quantum computer, time evolution of the quantum state under a second Hamiltonian to obtain an evolved quantum state, wherein the second Hamiltonian comprises a matrix of complex weights in the linear combination of observables;
measuring, by the quantum computer, the evolved quantum state to obtain measurement results; and
post-processing, by a classical processor, the measurement results to obtain an expectation value of the observable.

2. The method of claim 1, wherein:
the observables in the set of observables generate a Lie algebra;
the first Hamiltonian comprises a second linear combination of observables in the set of observables; and
the second Hamiltonian comprises a complex valued matrix of real weights in the second linear combination of observables and structure factors of the Lie algebra.

3. The method of claim 1, wherein:
the first Hamiltonian is an element of a Lie algebra;
the set of observables define a real vector space; and
the real vector space is invariant to conjugation of operators that are dependent on the Lie algebra.

4. The method of claim 1, wherein the first Hamiltonian has a larger dimension than the second Hamiltonian.

5. The method of claim 1, wherein
the vector of coefficients has a dimension M equal to a number of observables included in the set of observables; and
the register of qubits comprises at least ┌log(M)┐ qubits.

6. The method of claim 1, wherein encoding the vector of coefficients of the time-dependent representation of the observable in the quantum state of the register of qubits included in the quantum computer comprises preparing the register of qubits in an initial quantum state that is proportional to the vector of coefficients at an initial time.

7. The method of claim 6, wherein preparing the register of qubits in the initial quantum state costs poly(n), where n represents the number of qubits in the register.

8. The method of claim 6, wherein amplitudes of the initial quantum state are proportional to an expectation value of the observable with respect to an initial state of the quantum system.

9. The method of claim 1, wherein simulating time evolution of the quantum state under the second Hamiltonian to obtain the evolved quantum state comprises performing a simulation in space equal to the dimension of the vector of coefficients.

10. The method of claim 1, wherein amplitudes of the evolved quantum state are proportional to a time-dependent expectation value of the observable with respect to an initial state of the quantum system.

11. The method of claim 1, wherein simulating time evolution of the quantum state under the second Hamiltonian for a time t comprises complexity poly(n,t), where n represents the number of qubits in the system.

12. The method of claim 1, wherein the quantum system comprises a spin system.

13. The method of claim 12, wherein:
the first Hamiltonian comprises an Ising model in a transverse field;
observables included in the first Hamiltonian generate a Lie algebra of a special unitary group of degree N, wherein N represents a number of spin orbitals in the quantum system; and either
the encoded vector of coefficients of the time-dependent representation of the observable is proportional to expectation values of the observables included in the first Hamiltonian, the observables comprising {XⱼXₖ, YⱼYₖ, Zⱼ} where Xⱼ represents a Pauli X operator applied to spin j, Yⱼ represents a Pauli Y operator applied to spin j, and Zⱼ represents a Pauli Z operator applied to spin j; or
the encoded vector of coefficients of the time-dependent representation of the observable is proportional to expectation values of the observables included in the first Hamiltonian, the observables comprising {XⱼXₖX_{j′}X_{k′},XⱼXₖY_{j′}Y_{k′},XⱼXₖZ_{j′},YⱼYₖY_{j′}Y_{k′},YⱼYₖZ_{j′},ZⱼZₖ}.

14. The method of claim 1, wherein the quantum system comprises a free fermion system on a lattice.

15. The method of claim 14, wherein:
the first Hamiltonian comprises a linear combination of products of fermionic creation and annihilation operators; and
the set of observables generate a Lie algebra of a unitary group of degree N, wherein N represents a number of lattice sites in the lattice.

16. The method of claim 15, wherein the quantum simulation simulates dynamics of the first Hamiltonian within a one-excitation manifold and wherein each observable in the set of observables is equal to a sum of an annihilation operator for a respective spin and a creation operator for the respective spin.

17. The method of claim 1, wherein:
the quantum simulation simulates Landau-Lifshits dynamics and the observables in the set of observables generate a Lie algebra of a unitary group of degree N, wherein N represents system size;
the quantum simulation simulates the dynamics of a fermionic system and the observables in the set of observables generate a Lie algebra of a special unitary group of degree 2N; or
the quantum simulation simulates the dynamics of a bosonic system and the observables in the set of observables generate a Lie algebra of a sympletic group of degree 2N.

18. The method of claim 1, wherein the observable generated from the set of observables comprises an element of the set of observables or a product of elements of the set of observables.

19. A system comprising:
a quantum computer; and
a classical computer coupled to the quantum computer, the classical computer comprising:
one or more data processing apparatuses; and
non-transitory computer readable storage media in data communication with the one or more data processing apparatuses and storing instructions executable by the data processing apparatuses;
wherein the system is configured to perform operations for quantum simulation of a quantum system characterized by a first Hamiltonian, the operations comprising:
for an observable generated from a set of observables, wherein a commutator of each observable in the set of observables with the first Hamiltonian is equal to a linear combination of observables in the set of observables:
encoding, by a quantum computer, a vector of coefficients of a time-dependent representation of the observable in a quantum state of a register of qubits included in the quantum computer;
simulating, by the quantum computer, time evolution of the quantum state under a second Hamiltonian to obtain an evolved quantum state, wherein the second Hamiltonian comprises a matrix of complex weights in the linear combination of observables;
measuring, by the quantum computer, the evolved quantum state to obtain measurement results; and
post-processing, by a classical processor, the measurement results to obtain an expectation value of the observable.

20. The system of claim 19, wherein the quantum computer comprises a fault tolerant quantum computer.

21. A method for spectroscopy of a quantum system characterized by a first Hamiltonian, the method comprising:
for a set of observables, wherein a commutator of each observable in the set of observables with the first Hamiltonian is equal to a linear combination of observables in the set of observables:
mapping, by a classical processor, the first Hamiltonian to a second Hamiltonian with lower dimension than the first Hamiltonian, comprising generating a matrix wherein elements of the matrix correspond to respective complex weights in the linear combinations of observables;
performing, by a quantum computer, spectroscopy on the second Hamiltonian to obtain spectroscopy data; and
processing, by the classical processor, the spectroscopy data to determine spectral and response properties of the quantum system.

22. The method of claim 21, wherein:
the observables in the set of observables generate a Lie algebra;
the first Hamiltonian comprises a second linear combination of observables in the set of observables; and
the second Hamiltonian comprises a complex valued matrix of real weights in the second linear combination of observables and structure factors of the Lie algebra.

23. The method of claim 21, wherein:
the first Hamiltonian is an element of a Lie algebra;
the set of observables define a real vector space; and
the real vector space is invariant to conjugation of operators that are dependent on the Lie algebra.

24. The method of claim 21, wherein performing spectroscopy on the second Hamiltonian comprises implementing a quantum Kernel Polynomial method.

25. The method of claim 24, further comprising using block encodings of the second Hamiltonian.

26. The method of claim 21, wherein the quantum system comprises a free fermion system on a lattice.

27. The method of claim 26, wherein:
the first Hamiltonian comprises a linear combination of products of fermionic creation and annihilation operators; and
the set of observables generate a Lie algebra of a unitary group of degree N, wherein N represents a number of lattice sites in the lattice.

28. The method of claim 21, wherein the quantum system comprises a spin system.

29. A system comprising:
a quantum computer; and
a classical computer coupled to the quantum computer, the classical computer comprising:
one or more data processing apparatuses; and
non-transitory computer readable storage media in data communication with the one or more data processing apparatuses and storing instructions executable by the data processing apparatuses;
wherein the system is configured to perform operations for spectroscopy of a quantum system characterized by a first Hamiltonian, the operations comprising:
for a set of observables, wherein a commutator of each observable in the set of observables with the first Hamiltonian is equal to a linear combination of observables in the set of observables:
mapping, by a classical processor, the first Hamiltonian to a second Hamiltonian with lower dimension than the first Hamiltonian, comprising generating a matrix wherein elements of the matrix correspond to respective complex weights in the linear combinations of observables;
performing, by a quantum computer, spectroscopy on the second Hamiltonian to obtain spectroscopy data; and
processing, by the classical processor, the spectroscopy data to determine spectral and response properties of the quantum system.

30. The system of claim 9, wherein the quantum computer comprises a fault tolerant quantum computer.
